(19) United States
(12) Patent Application Publication
(10) Pub. No.: US 2023/0239777 A1
(43) Pub. Date: Jul. 27, 2023

(54) IMAGING DEVICE, METHOD FOR CONTROLLING IMAGING DEVICE, CONTROL PROGRAM, INFORMATION PROCESSING DEVICE, METHOD FOR CONTROLLING INFORMATION PROCESSING DEVICE, AND CONTROL PROGRAM

(71) Applicant: Sony Group Corporation, Tokyo (JP)

(72) Inventors: Ichiro SUDO, Tokyo (JP); Yuya KIHARA, Tokyo (JP); Keita SHIRANE, Tokyo (JP)

(73) Assignee: Sony Group Corporation, Tokyo (JP)

(21) Appl. No.: 17/786,455

(22) PCT Filed: Nov. 6, 2020
(86) PCT No.: PCT/JP2020/041526

§ 371 Date: Dec. 16, 2022

(30) Foreign Application Priority Data
Dec. 24, 2019 (JP) 2019-232707

(51) Int. Cl. H04W 48/18; H04L 65/61; H04N 21/61

(52) U.S. Cl. CPC H04W 48/18; H04L 65/61; H04N 21/6131

(57) ABSTRACT

An imaging device includes: a communication unit that communicates by use of both or one of a first communication scheme and a second communication scheme capable of communicating at a higher speed than the first communication scheme; a determination unit that determines whether the second communication scheme is available; and a function control unit that performs control related to a function according to a determination result of the determination unit.

### TECHNICAL FIELD

The present technology relates to an imaging device, a method for controlling an imaging device, a control program, an information processing device, a method for controlling an information processing device, and a control program.

### BACKGROUND ART

Communication schemes used for the Internet and the like are defined by the name of “generation (G)”, and new communication schemes are proposed and spread every few years. At present, the fourth generation mobile communication system (4G) is widely spread, and the fifth generation mobile communication system (5G), which is a new generation communication scheme, is next spreading (Patent Document 1). 5G is characterized by enabling higher speed and larger capacity communication, lower delay, and massive machine type communication as compared with 4G, which is an older generation than 5G. Furthermore, 6G, which is the next communication scheme of 5G, has already been proposed.

### CITATION LIST

### Patent Document

Patent Document 1: Japanese Patent Application Laid-Open No. 2019-004277

### SUMMARY OF THE INVENTION

### Problems to Be Solved by the Invention

However, it is common to start commercial services of a new communication scheme in some countries or regions before the new communication scheme is widely spread. Therefore, a user may not know whether the new communication scheme can be used with a device that the user is currently using. In a case where the user can use the new communication scheme with the device that the user is currently using, the user uses the new communication scheme and adapts settings or the like of various functions of the device to the new communication scheme so as to be able to effectively utilize advantages of the new communication scheme.

The present technology has been made in view of such a point, and an object of the present technology is to provide an imaging device, a method for controlling an imaging device, a control program, an information processing device, a method for controlling an information processing device, and a control program capable of effectively utilizing a specific communication scheme by performing function control according to the communication scheme in a case where the specific communication scheme can be used.

### Solutions to Problems

In order to solve the above-described problem, a first technology is an imaging device including: a communication unit that communicates by use of both or one of a first communication scheme and a second communication scheme capable of communicating at a higher speed than the first communication scheme; a determination unit that determines whether the second communication scheme is available; and a function control unit that performs control related to a function according to a determination result of the determination unit.

Furthermore, a second technology is a method for controlling an imaging device capable of communicating by use of both or one of a first communication scheme and a second communication scheme capable of communicating at a higher speed than the first communication scheme, the method including: determining whether the second communication scheme is available; and performing control related to a function according to a determination result.

Furthermore, a third technology is a control program for causing a computer to execute a method for controlling an imaging device capable of communicating by use of both or one of a first communication scheme and a second communication scheme capable of communicating at a higher speed than the first communication scheme, the method including: determining whether the second communication scheme is available; and performing control related to a function according to a determination result.

Furthermore, a fourth technology is an information processing device including: a communication unit that communicates with an imaging device; and a reception control unit that performs control to receive data transmitted from the imaging device by first reception processing and second reception processing in a case where information indicating that the imaging device communicates by a predetermined communication scheme is received.

Furthermore, a fifth technology is a method for controlling an information processing device, the method including: communicating with an imaging device; and performing control to receive data transmitted from the imaging device by first reception processing and second reception processing in a case where information indicating that the imaging device communicates by a predetermined communication scheme is received.

Furthermore, a sixth technology is a control program for causing a computer to execute a method for controlling an information processing device, the method including: communicating with an imaging device; and performing control to receive data transmitted from the imaging device by first reception processing and second reception processing in a case where information indicating that the imaging device communicates by a predetermined communication scheme is received.

### BRIEF DESCRIPTION OF DRAWINGS

FIG. 1 is a block diagram illustrating a configuration of an information processing system 10.

FIG. 2 is a block diagram illustrating a configuration of an imaging device 100.

FIG. 3 is a block diagram illustrating a configuration of a terminal device 200.

FIG. 4 is a block diagram illustrating a configuration of an information processing device 300.

FIG. 5 is an explanatory diagram of a video processing device 400.

FIG. 6 is an explanatory diagram of other examples of the video processing device 400.

FIG. 7 is a flowchart illustrating processing in the imaging device 100.

FIG. 8 is an explanatory diagram of area information generation.

FIG. 9 is an explanatory diagram of display control.

FIG. 10 is an explanatory diagram of the display control.

FIG. 11 is an explanatory diagram of the display control.

FIG. 12 is a block diagram illustrating an example of a configuration of MOJO.

FIG. 13 is an explanatory diagram of a first aspect of coverage in MOJO.

FIG. 14 is an explanatory diagram of a second aspect of the coverage in MOJO.

### MODE FOR CARRYING OUT THE INVENTION

Hereinafter, an embodiment of the present technology will be described with reference to the drawings. Note that the description will be made in the following order.

### 1. Embodiment

[1-1. Configuration of information processing system 10]
[1-2. Configuration of imaging device 100]
[1-3. Configuration of terminal device 200]
[1-4. Configuration of information processing device 300]
[1-5. Processing in imaging device 100]
[1-5-1. Control related to communication]
[1-5-2. Control related to function]
[1-5-3. Control related to display]

### 2. Application Example of Present Technology

[2-1. Configuration of MOJO]
[2-2. First aspect of coverage in MOJO]
[2-3. Second aspect of coverage in MOJO]

### 3. Modification

### 1. Embodiment

### 1. Configuration of Information Processing System 10]

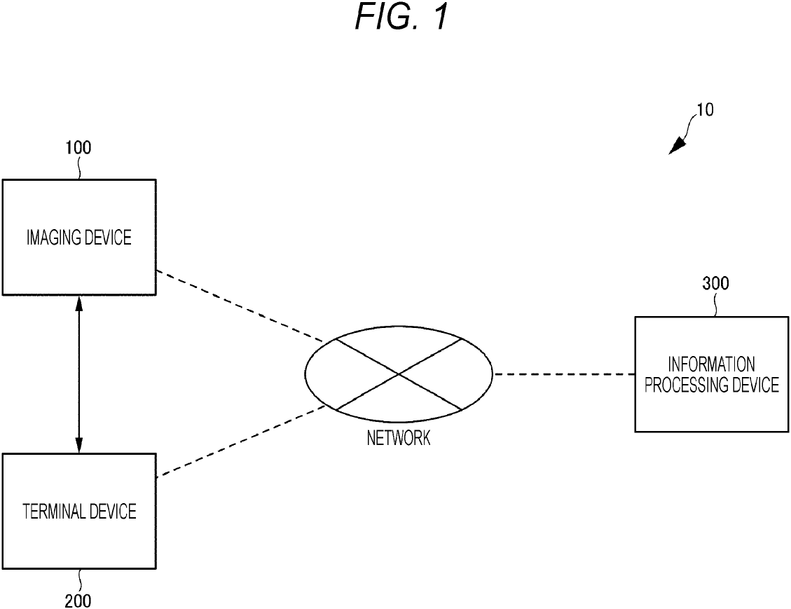

First, a configuration of an information processing system 10 will be described with reference to FIG. 1. The information processing system 10 includes an imaging device 100, a terminal device 200, and an information processing device 300. The imaging device 100 and the terminal device 200 are used by a photographer/videographer. The information processing device 300 is used by a person who receives imaging data or the like (video data, image data, audio data, or the like) generated by imaging performed by the photographer/videographer using the imaging device 100. The person who receives the data is a director or the like as an imaging director who requests coverage from the photographer/videographer, and in this case, the information processing device 300 is used in a broadcast station or the like where the imaging director works.

The information processing device 300 and each of the imaging device 100 and the terminal device 200 are connected via a network such as the Internet. Furthermore, the imaging device 100 and the terminal device 200 are connected by, for example, short-range wireless communication or the like, and are associated with each other.

The imaging device 100 performs imaging, and transmits data generated by the imaging to the information processing device 300 by use of a communication scheme such as 5G or 4G.

The terminal device 200 also has a camera function, and the photographer/videographer can transmit data generated by imaging to the information processing device 300 by use of the communication scheme such as 5G or 4G. Furthermore, the terminal device 200 can receive data generated by imaging performed by the imaging device 100 and transmit the data to the information processing device 300. Moreover, the terminal device 200 can also be used to receive imaging instruction information from the information processing device 300 and present the imaging instruction information to the photographer/videographer.

The information processing device 300 receives data transmitted from the imaging device 100 and the terminal device 200. Furthermore, the information processing device 300 can also transmit imaging instruction information to the terminal device 200.

The information processing system 10 is used, for example, in a broadcasting system that performs broadcasting by use of data generated by imaging performed by the imaging device 100.

### 2. Configuration of Imaging Device 100]

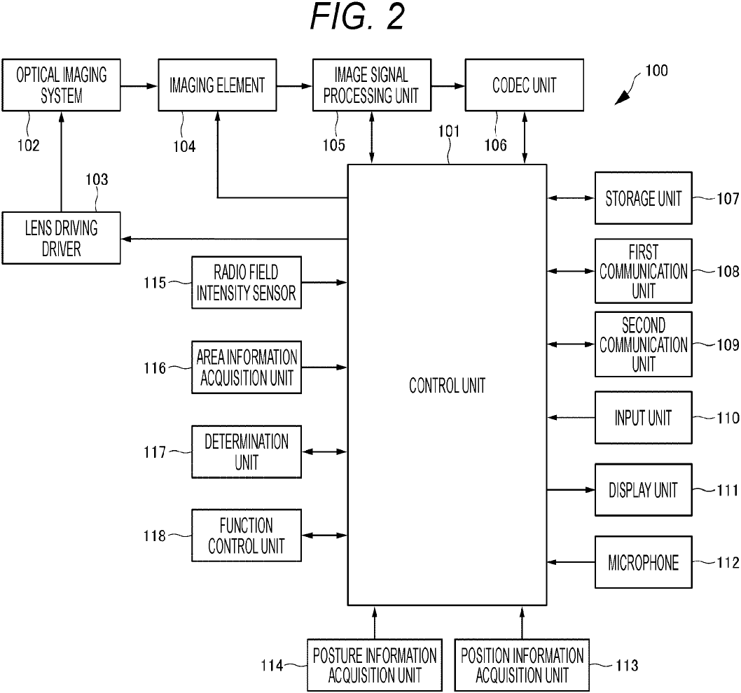

Next, a configuration of the imaging device 100 will be described with reference to the block diagram of FIG. 2. The imaging device 100 includes a control unit 101, an optical imaging system 102, a lens driving driver 103, an imaging element 104, an image signal processing unit 105, a codec unit 106, a storage unit 107, a first communication unit 108, a second communication unit 109, an input unit 110, a display unit 111, a microphone 112, a position information acquisition unit 113, a posture information acquisition unit 114, a radio field intensity sensor 115, an area information acquisition unit 116, a determination unit 117, and a function control unit 118.

The control unit 101 includes a central processing unit (CPU), a random access memory (RAM), a read only memory (ROM), and the like. The CPU executes various types of processing according to a program stored in the ROM and issues commands, thereby controlling the entire imaging device 100 and each unit of the imaging device 100. Furthermore, the control unit 101 stores imaging device 100 identification information for specifying the imaging device 100, which is required for connecting the imaging device 100 to the terminal device 200 and the information processing device 300, and controls the connection to the terminal device 200 and the information processing device 300.

The optical imaging system 102 includes an imaging lens for condensing light from a subject on the imaging element 104, a drive mechanism for moving the imaging lens to perform focusing and zooming, a shutter mechanism, an iris mechanism, and the like. These are driven on the basis of control signals from the control unit 101 and the lens driving driver 103. An optical image of the subject obtained through the optical imaging system 102 is formed on the imaging element 104.

The lens driving driver 103 includes, for example, a microcomputer or the like, and performs autofocusing so as to focus on a target subject by moving the imaging lens by a predetermined amount along the optical axis direction under the control of the control unit 101. Furthermore, the lens driving driver 103 controls operations of the drive mechanism, the shutter mechanism, the iris mechanism, and the like of the optical imaging system 102 under the control of the control unit 101. As a result, the exposure time (shutter speed), the aperture value (F value), and the like are adjusted.

The imaging element 104 photoelectrically converts incident light from a subject obtained through the imaging lens into a charge amount and outputs an imaging signal. The imaging element 104 then outputs the pixel signal to the image signal processing unit 105. As the imaging element 104, a charge coupled device (CCD), a complementary metal oxide semiconductor (CMOS), or the like is used.

The image signal processing unit 105 performs sample-and-hold, which is for maintaining a favorable signal/noise (S/N) ratio by correlated double sampling (CDS) processing, auto gain control (AGC) processing, analog/digital (A/D) conversion, and the like on the imaging signal output from the imaging element 104 to create an image signal. Furthermore, the image signal processing unit 105 performs processing for recording on an image signal for recording, and performs processing for display on an image signal for display.

The codec unit 106 performs, for example, encoding processing for recording or communication on an image signal subjected to predetermined processing.

The storage unit 107 is, for example, a mass storage medium such as a hard disk or a flash memory. Video data and image data processed by the image signal processing unit 105 and the codec unit 106 are stored in a compressed state or an uncompressed state on the basis of a predetermined standard. Furthermore, an exchangeable image file format (EXIF) including additional information such as information regarding the stored data, imaging position information indicating the imaging position, or imaging time information indicating the imaging date and time is also stored in association with the data.

The first communication unit 108 is a communication module for transmitting and receiving data and various types of information to and from the information processing device 300 by a communication scheme other than 5G. Communication schemes other than 5G include the fourth generation mobile communication system (4G) and Long Term Evolution (LTE). Here, the description will be made assuming that the communication scheme other than 5G is 4G. Note that some communication modules for 5G also have a 4G function, and in this case, the number of communication units may be one. A communication scheme slower than 5G and having a smaller communication capacity than 5G, which includes 4G, corresponds to a first communication scheme in the claims.

The second communication unit 109 is a communication module for transmitting and receiving data and various types of information to and from the information processing device 300 by use of 5G. 5G corresponds to a second communication scheme in the claims.

Note that some communication modules for 5G also have the 4G function, and in this case, the number of communication units may be one. However, in a case where 5G and 4G are used simultaneously, two communication units are required for 5G and 4G.

Note that the imaging device 100 may include a communication unit capable of connecting to the Internet, another device, and the like, such as a wireless local area network (LAN), a wide area network (WAN), or wireless fidelity (Wi-Fi). Furthermore, communication between the imaging device 100 and the terminal device 200 may be short-range wireless communication such as near field communication (NFC) or ZigBee (registered trademark), or tethering connection such as Wi-Fi tethering, universal serial bus (USB) tethering, or Bluetooth (registered trademark) tethering.

The input unit 110 is used by a user to give various instructions or the like to the imaging device 100. When an input is made to the input unit 110 by the user, a control signal corresponding to the input is generated and supplied to the control unit 101. The control unit 101 then performs various types of processing corresponding to the control signal. Examples of the input unit include, in addition to a shutter button for shutter input and a physical button for various operations, a touch panel, a touch screen integrally configured with a display as the display unit 111, and the like.

The display unit 111 is a display device such as a display that displays a through-image as an image signal for display, which has been subjected to processing for display by the image signal processing unit 105 and the codec unit 106, an image or video subjected to image processing for recording by the image signal processing unit 105 and stored in the storage unit 107, a graphical user interface (GUI), and the like.

The microphone 112 is for recording sound in video capturing.

The position information acquisition unit 113 has a global positioning system (GPS) function or simultaneous localization and mapping (SLAM) function, and acquires the current position of the terminal device 200 as, for example, coordinate information.

The posture information acquisition unit 114 is an inertial measurement unit (IMU) module or the like, which detects an angular velocity. The IMU module is an inertial measurement device, and obtains a three-dimensional angular velocity and acceleration by a biaxial or triaxial acceleration sensor, angular velocity sensor, gyro sensor, or the like to detect the posture, orientation, or the like of the imaging device 100.

The radio field intensity sensor 115 is a sensor for measuring the radio field intensity in a millimeter wave band of 5G in the communication by the first communication unit 108. The radio field intensity information detected by the radio field intensity sensor 115 is supplied to the determination unit 117.

The area information acquisition unit 116 acquires information indicating a cover area as a range in which 5G is usable around the terminal device 200. The area information can be acquired by reception of the area information indicating the 5G available range around the terminal device 200, which is provided by a communication carrier, on the basis of the position information of the terminal device 200 acquired by the position information acquisition unit 113.

Furthermore, the area information acquisition unit 116 can acquire the area information even by creating a map indicating the 5G available range around the imaging device 100 by itself. The creation of the area information will be described later.

The determination unit 117 determines whether the imaging device 100 can currently use 5G on the basis of the radio field intensity information from the radio field intensity sensor 115 and the area information from the area information acquisition unit 116. Whether 5G is available can be determined on the basis of whether or not the radio field intensity in the frequency band of 5G is equal to or greater than a predetermined value. Furthermore, referring to the area information and confirming whether or not the imaging device 100 is within an area where 5G is available makes it possible to determine whether 5G is available. The determination result is supplied to the function control unit 118.

The function control unit 118 performs control related to a function of the imaging device 100 depending on whether 5G is available or unavailable according to the determination result of the determination unit 117. The control related to the function includes control for switching the function itself and control for switching parameters without switching the function. Details of the function control will be described later.

Note that a state in which “5G is available” is a state in which stable communication can be performed with the radio field intensity being equal to or higher than a certain level, a state in which the imaging device 100 is within a 5G available range, or both of these states. Furthermore, a state in which “5G is unavailable” is a state in which stable communication cannot be performed with the radio field intensity being equal to or lower than a certain level, a state in which the imaging device 100 is outside a 5G available range, or both of these states.

The imaging device 100 is configured as described above. The imaging device 100 may be a smartphone, a tablet terminal, a wearable device, a portable game machine, or the like having a camera function in addition to a device specialized in the camera function, such as a digital camera, a single-lens reflex camera, a camcorder, a business camera, or a professional imaging device.

### 3. Configuration of Terminal Device 200]

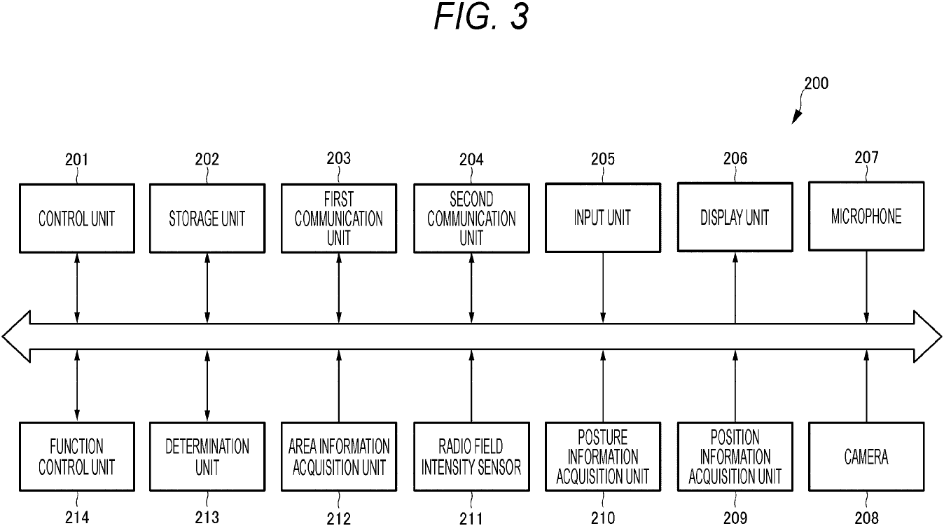

Next, a configuration of the terminal device 200 will be described with reference to FIG. 3. The terminal device 200 includes a control unit 201, a storage unit 202, a first communication unit 203, a second communication unit 204, an input unit 205, a display unit 206, a microphone 207, a camera 208, a position information acquisition unit 209, a posture information acquisition unit 210, a radio field intensity sensor 211, an area information acquisition unit 212, a determination unit 213, and a function control unit 214.

The control unit 201 includes a CPU, a RAM, a ROM, and the like. The CPU executes various types of processing according to a program stored in the ROM and issues commands, thereby controlling the entire terminal device 200 and each unit of the terminal device 200. Furthermore, the control unit 201 stores terminal device 200 identification information for specifying the terminal device 200, which is required for connecting the terminal device 200 to the imaging device 100 and the information processing device 300, and controls the connection to the imaging device 100 and the information processing device 300 via the first communication unit 203 or the second communication unit 204.

The storage unit 202 is, for example, a mass storage medium such as a hard disk or a flash memory. The storage unit 202 stores data generated by imaging performed by the camera 208, various applications used by the terminal device 200, and the like.

The first communication unit 203 is a communication module for transmitting and receiving data and various types of information to and from the information processing device 300 by 4G, which is the communication scheme other than 5G. Note that some communication modules for 5G also have the 4G function, and in this case, the number of communication units may be one.

The second communication unit 204 is a communication module for transmitting and receiving data and various types of information to and from the information processing device 300 by use of 5G.

Note that some communication modules for 5G also have the 4G function, and in this case, the number of communication units may be one. However, in a case where 5G and 4G are used simultaneously, two communication units are required for 5G and 4G.

Note that the terminal device 200 may include a communication unit capable of connecting to the Internet, another device, and the like, such as a wireless LAN, a WAN, or Wi-Fi. Furthermore, communication between the imaging device 100 and the terminal device 200 may be short-range wireless communication such as NFC or ZigBee, or tethering connection such as Wi-Fi tethering, USB tethering, or Bluetooth (registered trademark) tethering.

The input unit 205 is used by a user to input information or messages and give various instructions or the like to the terminal device 200. When an input is made to the input unit 205 by the user, a control signal corresponding to the input is generated and supplied to the control unit 201. The control unit 201 then performs various types of processing corresponding to the control signal. Examples of the input unit 205 include, in addition to a physical button, a touch panel, a touch screen integrally configured with a display as the display unit 206, and the like.

The display unit 206 is a display device such as a display that displays a video, an image, a GUI, and the like.

The microphone 207 is used as a sound input device in sound recording at the time of capturing a video, in a voice input operation, in a voice call, in a video call, and the like.

The camera 208 includes a lens, an imaging element, an image signal processing unit, a codec unit, and the like, and captures a video and an image to generate video data, image data, and the like.

Since the position information acquisition unit 209, the posture information acquisition unit 210, the radio field intensity sensor 211, the area information acquisition unit 212, the determination unit 213, and the function control unit 214 are similar to those included in the imaging device 100, the description thereof will be omitted.

The terminal device 200 is configured as described above. Specific examples of the terminal device 200 include, for example, a camera, a smartphone, a tablet terminal, a personal computer, a wearable device, a portable game machine, and the like.

### 4. Configuration of Information Processing Device 300]

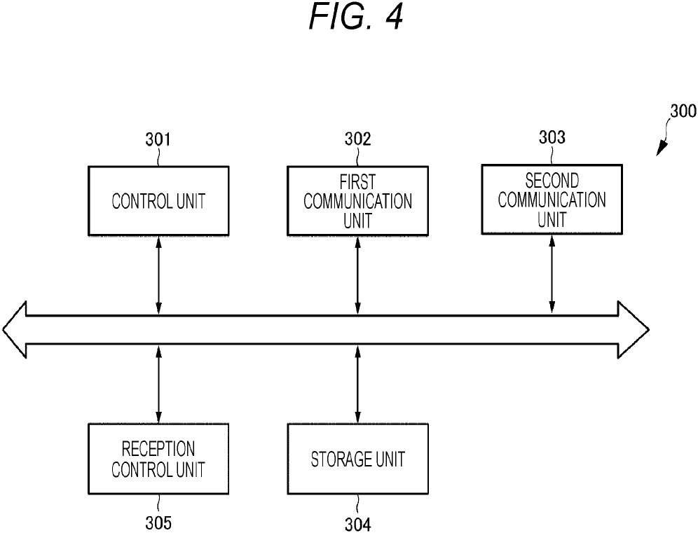

Next, a configuration of the information processing device 300 will be described with reference to FIG. 4. The information processing device 300 includes a control unit 301, a first communication unit 302, a second communication unit 303, a storage unit 304, and a reception control unit 305.

The control unit 301 includes a CPU, a RAM, a ROM, and the like, and controls the entire information processing device 300 and each unit of the information processing device 300 by the CPU executing various types of processing according to a program stored in the ROM and issuing commands.

The first communication unit 302 is a communication module for transmitting and receiving data and various types of information to and from the imaging device 100 and the terminal device 200 by 4G, which is the communication scheme other than 5G.

The second communication unit 303 is a communication module for transmitting and receiving data and various types of information to and from the imaging device 100 and the terminal device 200 by use of 5G.

Note that some communication modules for 5G also have the 4G function, and in this case, the number of communication units may be one. However, in a case where 5G and 4G are used simultaneously, two communication units are required for 5G and 4G.

The storage unit 304 stores and manages received data, identification information of the imaging device 100 and the terminal device 200, and the like.

In a case where information indicating that the imaging device 100 communicates by 5G is received from the imaging device 100, the reception control unit 305 performs reception control to receive the data transmitted from the imaging device 100 by one of first reception processing and second reception processing or both in parallel.

The first reception processing is in a streaming format, and the second reception processing is in a downloading format.

Streaming is a method in which data can be used at the same time as reception of the data. For example, video data and audio data can be reproduced while being received. Streaming has advantages that waiting time until the data can be used by the reception side can be greatly shortened, the storage capacity of the reception side is not compressed, and the like. A field pick-up unit (FPU) or satellite news gathering (SNG) is used, and for example, it is possible for a coverage location and a studio to interact with each other in broadcasting by utilizing a low delay. Note that, unlike the downloading method, the data is not stored on the reception side, and thus, it is necessary to receive the data by streaming every time the data is used. Streaming has a disadvantage that a large-scale transmission device is required, and a disadvantage that video quality on the reception side is not stable in a case where transmission is performed by use of a relatively inexpensive IP.

Downloading is a method in which data can be used after reception of the data is completed. The data cannot be used until downloading is completed, but, once being downloaded, the data can be used at any time without being received again because the downloaded data is stored on the reception side. Furthermore, it takes more time to enable use of the data than streaming, but, when downloading is completed, the reception side can acquire the data in a complete state without deterioration. In addition, since downloading can be performed in a general personal computer or the like, and thus also has an advantage that equipment is inexpensive. Downloading has a disadvantage that it is difficult to predict the timing of completion of data reception on the reception side.

In recent years, a transmission device is used, in some cases, which has a bonding function by an IP capable of streaming and downloading. The transmission device capable of bonding can secure bandwidth, but it is necessary for a user to select in advance whether to perform streaming or downloading.

Furthermore, in a case where the imaging device 100 communicates by 4G, which is slower than 5G, the reception control unit 305 performs reception control to receive the data transmitted from the imaging device 100 by either the first reception processing or the second reception processing. This is because it is difficult to simultaneously perform both streaming and downloading by 4G, which is slower than 5G and has a smaller communication capacity than 5G. Which of streaming and downloading is prioritized may be set in advance by the user according to the type of data, the purpose of use of the data, or the like, or may be determined by the reception control unit 305 on the basis of the type of data to be transmitted.

Note that, in a case where the imaging device 100 communicates by 4G, which is slower than 5G, it is good to perform the reception processing such that the data is received by streaming as the first reception processing.

The information processing device 300 is configured as described above. The information processing device 300 may be configured by a program, and the program may be installed in a server or the like in advance, or may be distributed by downloading, a storage medium, or the like and installed in the server or the like by the user himself/herself. Furthermore, the information processing device 300 may be configured on a cloud. Moreover, the information processing device 300 may be implemented not only by a program but also by combination of a dedicated device by hardware having a function of the information processing device 300, a circuit, and the like.

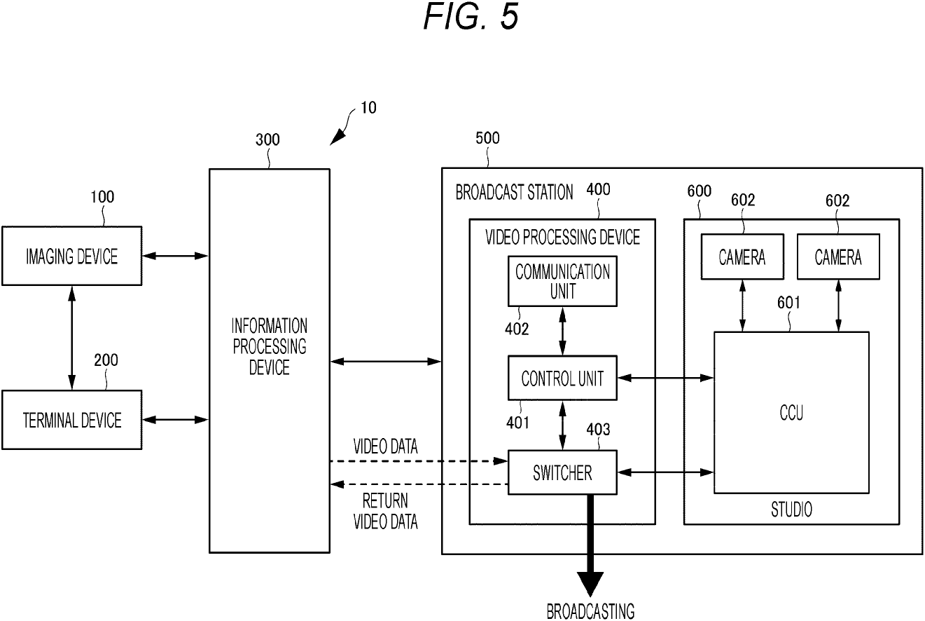

Note that, as illustrated in FIG. 5, the information processing device 300 is connected to an external video processing device 400 that performs editing processing for broadcasting on data. The video processing device 400 includes at least a control unit 401, a communication unit 402, and a switcher 403, and operates in a broadcast station 500, for example. Furthermore, the broadcast station 500 is provided with a studio 600.

In the studio 600, a producer, a director, an assistant director, a camera operator, and the like (hereinafter collectively referred to as staff) of the broadcast station 500 work for broadcasting. Furthermore, the studio 600 includes at least a CCU 601 and a camera 602. The CCU 601 performs processing on a video captured by the camera 602 to output the video and transmits data or the like. The camera 602 images a newscaster or the like that reports in the studio 600.

The control unit 401 includes a CPU, a RAM, a ROM, and the like, and controls the entire video processing device 400 and each unit of the video processing device 400 by the CPU executing various types of processing according to a program stored in the ROM and issuing commands. Furthermore, the control unit 401 performs video editing processing for broadcasting. Examples of the editing processing include division, combination, cropping, trimming, editing, subtitling, CG composition, effect addition, and the like of a video. However, the editing processing for broadcasting is not limited thereto, and any processing may be used as long as the processing is performed for broadcasting data.

The communication unit 402 is a communication module for transmitting and receiving various types of data, various types of information, and the like to and from the information processing device 300 and the like. Examples of the communication scheme include a wireless LAN, a WAN, Wi-Fi, 4G, and 5G.

The switcher 403 is a device that switches or mixes a plurality of input signals. In a case where there is a plurality of imaging devices 100, data captured by the plurality of imaging devices 100 and transmitted to the video processing device 400 via the information processing device 300 is collected in the switcher 403. Which of the imaging devices 100 is used for broadcasting data is then selected by switching with the switcher 403. Furthermore, when the video processing device 400 performs editing processing for broadcasting on the data to generate return data, the switcher 403 transmits the return data to the information processing device 300. The return data is transmitted to the terminal device 200 via the information processing device 300, for example.

The video processing device 400 may be configured by hardware, may be configured by a program, or may be configured on a cloud. The program may be installed in the server or the like having the function of the information processing device 300, or may be installed in another server.

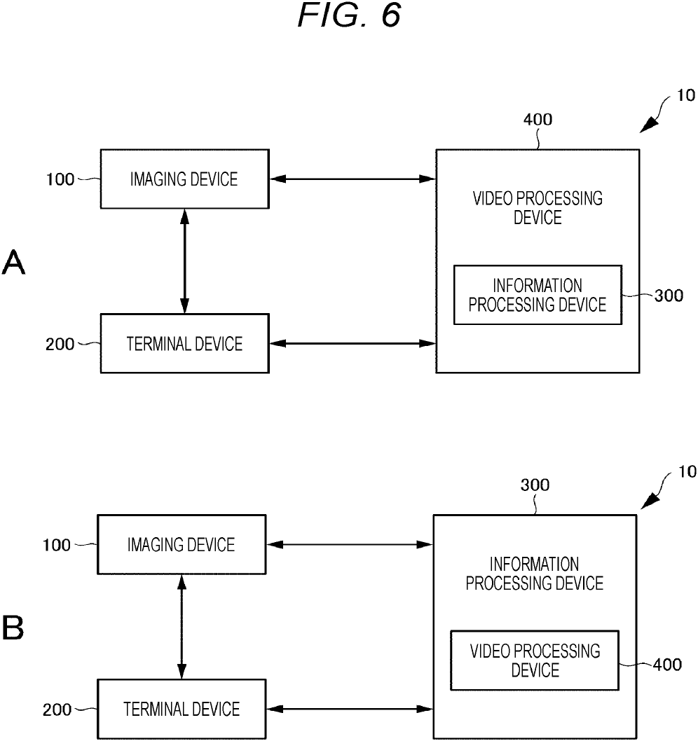

Note that the video processing device 400 may have the function as the information processing device 300 as illustrated in FIG. 6A, or the information processing device 300 may have the function as the video processing device 400 as illustrated in FIG. 6B. Although the broadcast station and the studio are omitted in FIG. 6, the information processing device 300 and the video processing device 400 may operate in the broadcast station as in FIG. 5.

### 5. Processing in Imaging Device 100]

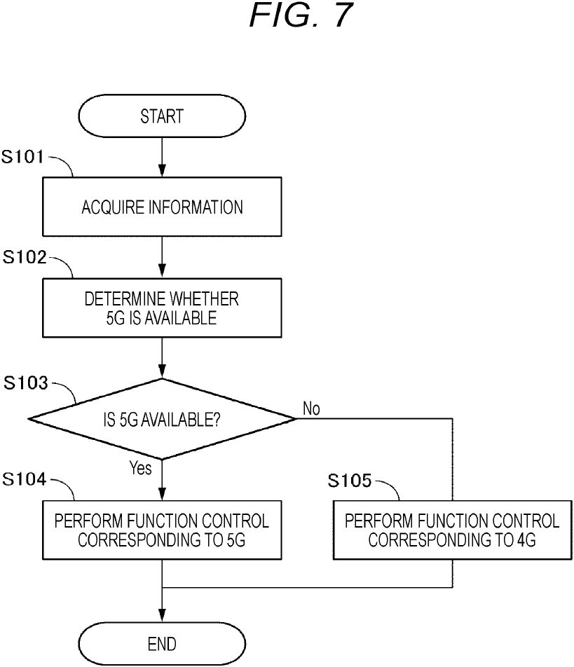

Next, processing in the imaging device 100 will be described with reference to the flowchart of FIG. 7.

First, in step S101, information used by the determination unit 117 to determine whether or not 5G is available, such as radio field intensity information of 5G acquired by the radio field intensity sensor 115 or area information acquired by the area information acquisition unit 116, is acquired.

Next, in step S102, the determination unit 117 determines whether the imaging device 100 can currently use 5G. The determination result is supplied to the function control unit 118.

As a result of the determination, in a case where the imaging device 100 can currently use 5G, the processing proceeds from step S103 to step S104, and the function control unit 118 performs function control corresponding to 5G (Yes in step S103).

On the other hand, in a case where the imaging device 100 cannot currently use 5G, the processing proceeds from step S103 to step S105, and the function control unit 118 performs function control corresponding to 4G (No in step S103).

The processing in the imaging device 100 is performed as described above.

### 5-1. Control Related to Communication]

Next, details of the control by the function control unit 118 of the imaging device 100 will be described. First, control related to communication will be described.

First control related to communication is control for switching the communication in the imaging device 100 to 5G in a case where 5G is available. Specifically, the first communication unit 108, which is a communication module for 4G, is turned off, and the second communication unit 109, which is a communication module for 5G, is turned on, so that the communication unit to be operated is switched and the second communication unit 109 communicates with a network by use of 5G.

Second control related to communication is control for communicating by both 5G and 4G in a case where 5G is available. Specifically, the second communication unit 109, which is a communication module for 5G, is turned on, and the first communication unit 108, which is a communication module for 4G, is also turned on, so that the two communication units are operated to communicate with the network by 4G and 5G. Using both 5G and 4G makes it possible, for example, to allocate 4G to transmission of data that does not require high speed, large capacity, or low delay (concomitant data of imaging data, image data, audio data, metadata, control data, and the like), and to allocate 5G to transmission of only large capacity video data. As a result, data can be efficiently transmitted.

The first control related to communication is control for switching to 5G, and the second control related to communication is combined use of 5G and 4G. Which control is to be performed may be set in advance for the imaging device 100 by the user, or may be determined in advance according to the type of data, the purpose of use of the data, or the like.

Third control related to communication is control for transmitting data in both the streaming format and the downloading format in parallel in a case where 5G is available. In this case, the resolution of video data or image data to be transmitted by streaming is lowered, or the frame rate of the video data is lowered, so that the size of the data is made smaller than that of the video data to be transmitted in the downloading format. As a result, transmission of the data with the lowest delay by streaming and transmission of the video data and the image data with high image quality by downloading can be performed in parallel. As a result, for example, it is possible to promptly broadcast the video data transmitted by streaming and to broadcast a video with higher image quality later by use of the video data transmitted by downloading.

Fourth control related to communication is such control that, in a case where 5G is available and communication is performed by 5G, data generated by imaging is directly transmitted to an external storage medium or storage device such as the information processing device 300, a server, or a cloud and stored there. The direct transmission is to transmit the generated data to the external storage medium or storage device before storing the data in the storage unit 107 is completed or without storing the data in the storage unit 107. Conventionally, the data is transmitted to the information processing device 300 or the server after storing the data in the storage unit 107 of the imaging device 100 is completed. However, directly transmitting the data to the external storage medium or storage device and storing the data before storing the data in the storage unit 107 is completed or without storing the data in the storage unit 107 makes it possible to shorten the time until the start of use of the data. Note that the data may be stored in the storage unit 107 in parallel with the direct transmission of the data or after completion of the direct transmission. This control can be implemented by transmitting the data generated by imaging to the information processing device 300 via the second communication unit 109 instead of storing the data in the storage unit 107.

Note that, when the data is stored in the information processing device 300 or the cloud server, a group, a folder, a directory, or the like for storing the data may be set in advance according to the imaging device 100 or the terminal device 200 as a transmission source. For example, the setting may be made in advance on the basis of device identification information or imaging contents, the device on the reception side may distribute the data, or the device on the transmission side may select a data storage destination. Note that the video data may be stored in the storage unit 107 in parallel with or after completion of transmission to the information processing device 300.

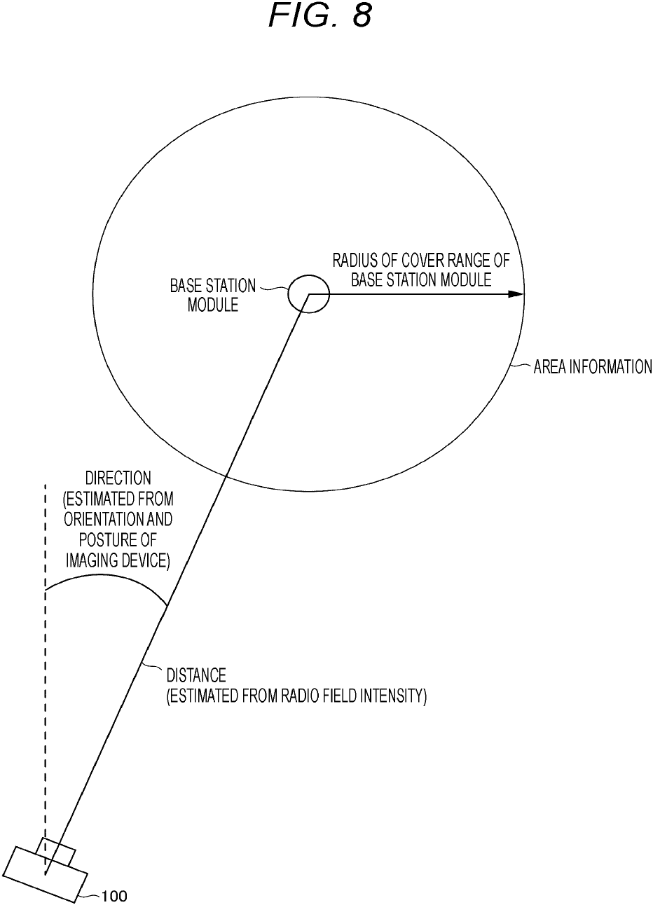

Fifth control related to communication is generation of area information indicating a 5G available range. Here, the generation of the area information by the area information acquisition unit 116 will be described with reference to FIG. 8.

In order to generate the area information, model number information of a module of a base station in which the imaging device 100 communicates in the millimeter wave band of 5G and information indicating the direction of the base station from the imaging device 100 are required.

In a case where the model number information of the base station module is described in, for example, a service set identifier (SSID), a basic service set indentifier (BSSID), or the like, the model number information of the base station module can be acquired from the SSID or the BSSID. Furthermore, in a case where the model number information is not described in the SSID or the BSSID, it is possible to access information provided by a manufacturer of the base station module and acquire the model number information on the basis of the SSID or the like. When the model number information of the base station module is acquired, the maximum radio field intensity of the base station module can be inferred by reference to product information provided by the manufacturer.

The cover range of each base station module that communicates in the millimeter wave band of 5G is about 100 m in radius, and the shape of the cover range is circular or fan-shaped in many cases. Furthermore, the radio field intensity of the base station module is the strongest near the base station module, and becomes weaker as the distance from the base station module increases (attenuates in proportion to the square of the distance). Moreover, millimeter waves also have a characteristic of high straightness.

The area information indicating the 5G available range can be generated by use of the above-described characteristic of the millimeter waves. Since the millimeter waves have high straightness, it can be estimated that the base station module exists in the direction in which the radio waves are strongest. Changing the orientation of the imaging device 100 makes it possible for the posture information acquisition unit 114 to detect the orientation and posture of the imaging device 100 oriented in the direction in which the radio waves are strongest. Note that the direction can be obtained on the basis of, for example, east, west, north, and south, or the like.

Furthermore, the distance from the current position of the imaging device 100 to the base station can be estimated from the above-described relationship between the distance and the radio field intensity. The position of the base station can be estimated from the direction and position, and the cover range of the base station can be estimated by the assumption that the cover range has a radius of about 100 m from the position of the base station. As a result, the area information indicating the 5G available range can be generated as illustrated in FIG. 8.

Furthermore, it is also possible to create a heat map of the radio field intensity from the change in the radio field intensity detected by the radio field intensity sensor 115 when the photographer/videographer possessing the imaging device 100 moves between two points. Even when this heat map is used, the area information indicating the 5G available range can be generated.

Using such a method makes it possible to obtain the area information even in a situation where the area information cannot be obtained from a communication carrier, such as in a foreign country, for example. Furthermore, the area information generation by the imaging device 100 can be performed in the background during imaging, or can be performed even in a state in which imaging is not being performed.

Note that, in a case where the area information is generated by the imaging device 100, the area information can be transmitted to the terminal device 200 to be shared. As a result, it is possible to display the area information on the terminal device 200 to confirm the 5G available range while the display unit 111 of the imaging device 100 is used as a viewfinder at the time of imaging or used for data confirmation.

### 5-2. Control Related to Imaging]

Next, control related to imaging by the function control unit 118 will be described.

First control related to imaging is change of the compression rate in a codec in the codec unit 106. In 5G, video data can be transmitted with higher speed, larger capacity communication, and lower delay than in 4G, and thus video data having a larger size can also be transmitted with a compression rate lower than the compression rate in the codec at the time of transmission in 4G. Thus, in a case where 5G is available. Lowering the compression rate makes it possible to improve the image quality of the video data. Furthermore, in a case where 5G is unavailable, the compression rate in the codec is increased to reduce the size of the video data, so that the time required for transmission in 4G can be shortened.

Second control related to imaging is change of the frame rate of video data. In 5G, video data can be transmitted with higher speed, larger capacity communication, and lower delay than in 4G, and thus video data having a larger size can also be transmitted with a higher frame rate than in transmission in 4G. Therefore, in a case where 5G is available, increasing the frame rate makes it possible to transmit the video data with high image quality. Furthermore, in a case where 5G is unavailable, the frame rate is lowered to reduce the size of the video data, so that the time required for transmission in 4G can be shortened.

Third control related to imaging is change of the resolution of video data or image data. In 5G, data can be transmitted with higher speed, larger capacity communication, and lower delay than in 4G, and thus video data and image data having a higher resolution and a larger size than in transmission in 4G can also be transmitted. Therefore, in a case where 5G is available, the resolution is increased so that the video data and the image data have high image quality. Furthermore, in a case where 5G is unavailable, the resolution is lowered to reduce the size of the data, so that the time required for transmission in 4G can be shortened.

Fourth control related to imaging is control for increasing the resolution of video data to be transmitted to the information processing device 300 by streaming in a case where communication in the imaging device 100 is switched to 5G as compared with the case of 4G. In 5G, data can be transmitted with higher speed, larger capacity communication, and lower delay than in 4G, and thus, in a case where 5G is available, video data having a higher resolution and a larger size can be transmitted by streaming in 5G. This enables streaming of the video data with high image quality. Examples of the resolution include 4 K and 8 K in the case of 5G, and HD in the case of 4G. Furthermore, in a case where 5G is unavailable, the resolution may be lowered to reduce the size of the data, so that transmission may be performed by streaming in 4G.

The above-described control related to imaging is performed by the function control unit 118 transmitting a control signal for instructing the image signal processing unit 105 or the codec unit 106 to change the above-described compression rate, frame rate, or resolution.

### 5-3. Control Related to Display]

Next, control related to display by the function control unit 118 will be described.

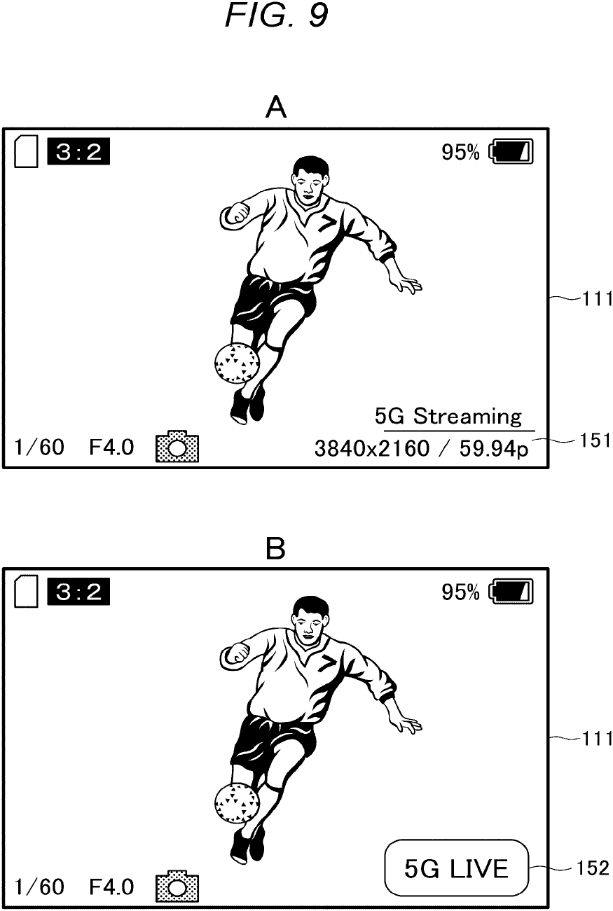

First display control causes the display unit 111 to display various parameters 151 switched as the imaging device 100 communicates by 5G in a case where communication is performed by 5G, as illustrated in FIG. 9A. Examples of the parameters include the resolution of streaming, the compression rate in the codec, the frame rate, and the like. As a result, the user can easily grasp the parameters switched as the imaging device 100 communicates by 5G.

Second display control causes the display unit 111 to display a button 152 for starting data transmission to the information processing device 300 in the streaming format, which is enabled only in a case where communication is performed by 5G, as illustrated in FIG. 9B. Note that, although the button 152 is displayed on the display unit 111 in FIG. 9B, provision of the button to the user may be implemented by change of a function assigned to a hardware button included in the imaging device 100. At this time, information indicating that the assignment of the function of the specific hardware button has been changed may be displayed on the display unit 111.

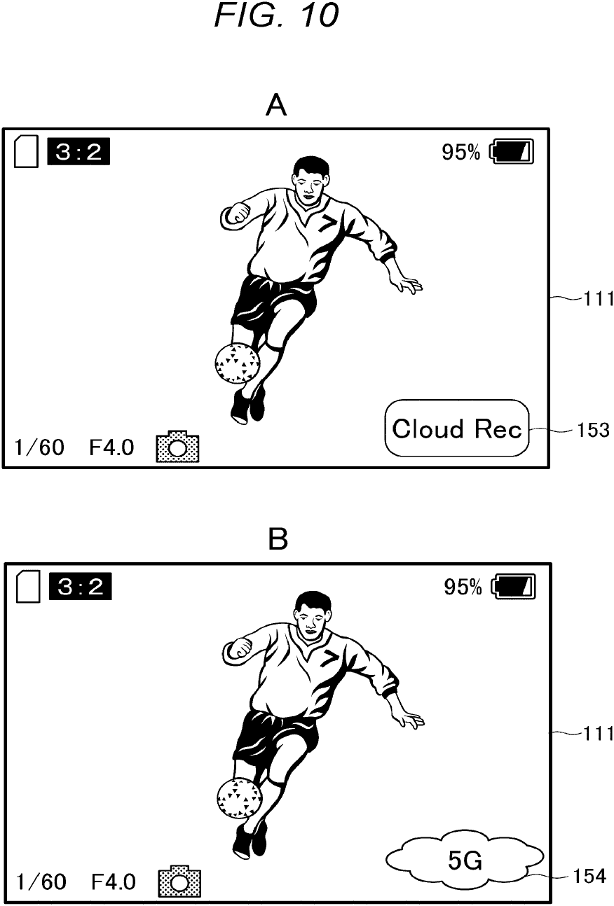

Third display control causes the display unit 111 to display a button 153 for starting direct transmission of data to the information processing device 300 or the cloud server, which is enabled only in a case where communication is performed by 5G, as illustrated in FIG. 10A. Note that, although the button 153 is displayed on the display unit 111 in FIG. 10A, provision of the button to the user may be implemented by change of a function assigned to a hardware button included in the imaging device 100. At this time, information indicating that the assignment of the function of the specific hardware button has been changed may be displayed on the display unit 111.

Fourth display control causes the display unit 111 to display an icon 154 indicating that 5G is available and that a specific function is enabled only in a case where communication is performed by 5G, as illustrated in FIG. 10B.

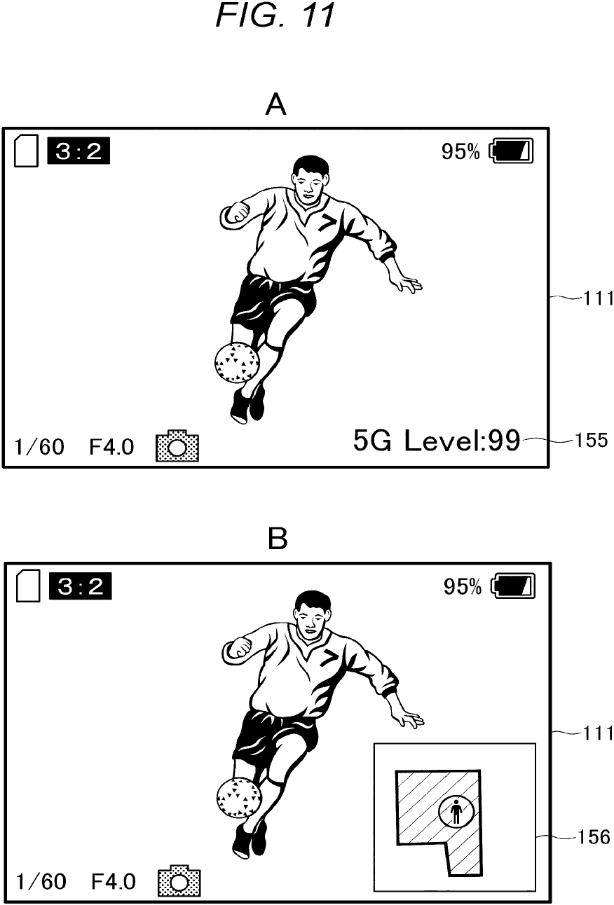

Fifth display control causes the display unit 111 to display information 155 indicating the radio field intensity of 5G acquired by the radio field intensity sensor 115, as illustrated in FIG. 11A. In the example of FIG. 11A, the radio field intensity is represented by a numerical value. As a result, the user can easily confirm the current radio field intensity of 5G. Note that the radio field intensity may be represented by an icon or the like instead of the numerical value.

Sixth display control causes the display unit 111 to display the current position of the imaging device 100 and area information 156 indicating a 5G available range on a map in a superimposed manner, as illustrated in FIG. 11B. As a result, the user can easily grasp the relationship between the current position of the user using the imaging device 100 and the 5G available range. With this display control, for example, the user can easily know how far the user can move while using 5G. In addition, the user can be guided to a position where 5G can be used.

Note that the plurality of types of control described above may be executed simultaneously instead of being executed by selection of one of them.

The processing by the function control unit 118 is performed as described above. According to the present technology, in a case where 5G can be used, various functions of the imaging device 100 are adapted to 5G by function control, so that it is possible to effectively utilize the advantages of 5G.

Note that, although the above-described embodiment has been described as processing in the imaging device 100, communication control, imaging control, and display control can be similarly performed in the terminal device 200 according to use of 5G. Furthermore, since the terminal device 200 also has a function as a camera, that is, a function as an imaging device, the terminal device 200 also corresponds to an imaging device in the claims.

Furthermore, the imaging device 100 and the terminal device 200 may be paired and connected by short-range wireless communication, the imaging device 100 may transmit data generated by imaging to the terminal device 200, and the terminal device 200 may transmit the data to the information processing device 300 by 5G. In this case, the imaging device 100 receives information indicating that the terminal device 200 has communicated by 5G from the terminal device 200, and performs function control in the imaging device 100, such as changing the resolution of the video data, the frame rate of the video data, or the compression rate in the codec.

### 2. Application Example of Present Technology

### 1. Configuration of MOJO]

Next, a specific application example of the present technology will be described. The present technology can be applied to a new reporting mechanism called mobile journalism (MOJO).

MOJO is journalism in which a reporter, a general public, or the like performs, coverage, reporting, or the like by use of the terminal device 200. With the spread of the Internet and the terminal device 200 such as a smartphone, even a general public or a freelance reporter who has no dedicated imaging device 100 or video editing device can easily image, edit, and provide a news report material by using an application in the terminal device 200, and MOJO enables more immediate reporting than before.

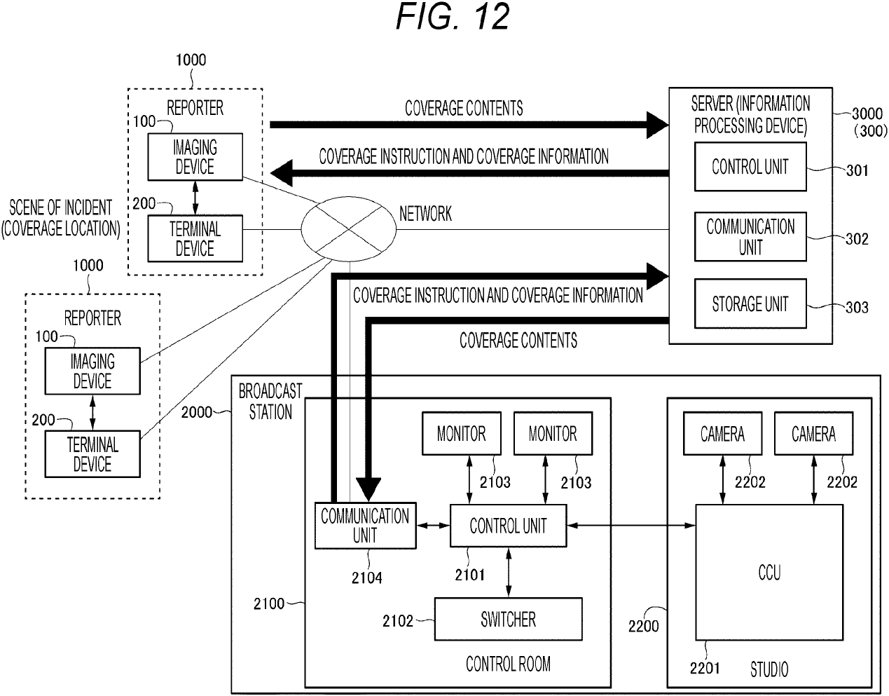

First, an example of a configuration in a case where coverage and reporting are performed in the MOJO format will be described with reference to FIG. 12. The coverage and reporting in the MOJO format includes, for example, a reporter 1000, a broadcast station 2000, and a server 3000. The broadcast station 2000 and the server 3000, as well as the imaging device 100 and the terminal device 200 used by the reporter 1000, are connected via a network such as the Internet. Note that the imaging device 100, the terminal device 200, and the information processing device 300 are similar to those described in the embodiment.

The reporter 1000 goes to a coverage location as the scene of an incident, covers the incident, and provides the broadcast station 2000 with coverage contents (video data, image data, audio data, text, or the like). The reporter 1000 covers the incident using the imaging device 100 and/or the terminal device 200.

The broadcast station 2000 is a business unit and/or equipment that instructs the reporter 1000 to cover an incident, performs predetermined editing processing for broadcasting on coverage contents provided from the reporter 1000, and broadcasts the coverage contents.

The server 3000 is the information processing device 300 according to the present technology, and is also responsible for transmission and reception of information, data, instructions, and the like between the broadcast station 2000 and the reporter 1000. The server 3000 may be managed and operated by the broadcast station 2000 itself, or an associated company, an associated group, or the like of the broadcast station 2000, or may be managed and operated by a company other than the broadcast station 2000 and used by the broadcast station 2000.

The server 3000 (information processing device 300) includes the control unit 301, the communication unit 302, and the data storage unit 304.

The control unit 301 includes a CPU, a RAM, a ROM, and the like, and controls the entire information processing device 300 and each unit of the information processing device 300 by the CPU executing various types of processing according to a program stored in the ROM and issuing commands.

The communication unit 302 is a communication module for transmitting and receiving various types of data, various types of information, and the like to and from the imaging device 100 and the terminal device 200. Examples of the communication scheme include a wireless LAN, a WAN, Wi-Fi, 4G, and 5G.

The data storage unit 304 stores and manages received video data, identification information and function information of the imaging device 100 and the terminal device 200, and the like. The information processing device 300 may transmit video data that is stored as an archive in the data storage unit 304 as necessary or requested to the imaging device 100 and the terminal device 200.

The broadcast station 2000 includes at least a control room 2100 and a studio 2200. In the control room 2100 and the studio 2200, a producer, a director, an assistant director, a camera operator, and the like (hereinafter collectively referred to as staff) of the broadcast station 2000 work for broadcasting a program.

The control room 2100 includes at least a control unit 2101, a switcher 2102, a monitor 2103, and a communication unit 2104. The control unit 2101 controls each unit of the control room 2100 and the entire control room 2100. The control unit 2101 further performs transmission and reception of video data and the like between the switcher 2102 and the monitor 2103, and transmission and reception of video data and the like between the control room 2100 and a camera control unit (CCU) 2201 of the studio 2200.

The switcher 2102 is a device that switches or mixes a plurality of input signals, and is used by a staff in charge of switching operation of a video displayed on the monitor 2103, for example. The monitor 2103 is a display device that displays various videos such as a video before broadcasting, a video for broadcasting, and a video subjected to processing for broadcasting.

Furthermore, the studio 2200 includes at least a CCU 2201 and a camera 2202. The CCU 2201 performs processing on a video captured by the camera 2202 to output the processed video and transmits video data or the like. The camera 2202 images a newscaster or the like that reports in the studio 2200.

As illustrated in FIG. 12, for example, a coverage instruction and coverage information are transmitted from the broadcast station 2000 to the reporter 1000 via the server 3000. The coverage information includes, for example, a date, an ID of a reporter, a coverage ID, a coverage place, a title, setting information of the imaging device 100, and the like.

When the reporter 1000 covers an incident on the basis of the coverage instruction and the coverage information, the reporter 1000 transmits coverage contents to the broadcast station 2000 via the server 3000. The coverage contents include, for example, a video, a still image, a sound, a text, and the like obtained by coverage.

In the broadcast station 2000, the staff performs composition, recording, editing, and the like of the program on the basis of the coverage contents transmitted from the reporter 1000, and broadcasts the coverage contents in the program.

### 2. First Aspect of Coverage in MOJO]

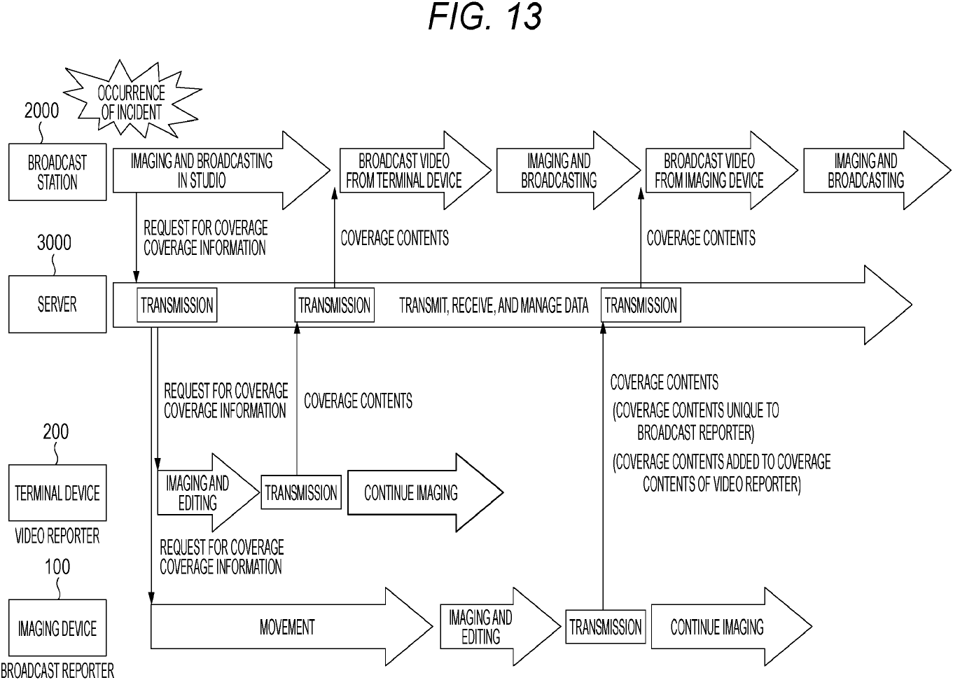

Next, a first aspect of coverage in MOJO will be described with reference to FIG. 13.

Reporters in MOJO include a citizen reporter (citizen reporter), a video reporter, and a broadcast reporter.

A citizen reporter is a general citizen who provides the broadcast station 2000 with a captured video or posts the captured video on the Internet. This is an existence that has been created by the spread of the terminal device 200 such as a smartphone, which allows ordinary citizens to easily image an incident. A citizen reporter covers an incident in a case where the citizen reporter happens to encounter the scene of the incident, and thus can report the incident more immediately than video reporters and broadcast reporters.

A video reporter is a staff member of the broadcast station 2000, a freelance reporter, or the like, and is a person whose occupation is to provide the broadcast station 2000 with a video captured by a device such as a smartphone or a digital camera, which has higher portability than a professional imaging device. Thus, a video reporter can report more quickly than a broadcast reporter.

A broadcast reporter is a staff member of the broadcast station 2000, a freelance reporter, or the like, and is a person whose occupation is to provide the broadcast station 2000 with a video captured by use of a professional imaging device. Since the professional imaging device is heavier and larger than the terminal device 200 such as a smartphone and the imaging device 100 such as a general digital camera, it takes more time to arrive at the scene of an incident and start coverage than the case of a citizen reporter and a video reporter. However, since imaging is performed by the professional imaging device, it is possible to perform detailed reporting with higher image quality than videos captured by a citizen reporter and a video reporter.

FIG. 13 illustrates a first coverage aspect of MOJO in which broadcasting is performed on the basis of coverage by a video reporter using the terminal device 200 and a broadcast reporter using the imaging device 100 as a professional imaging device.

In the first coverage aspect, first, the broadcast station 2000 requests coverage from the video reporter and the broadcast reporter via the server 3000 or directly when knowing the occurrence of an incident.

The video reporter who has received the request for coverage performs imaging, editing, and the like as coverage using the terminal device 200. Note that, in this example, since the terminal device 200 has higher portability and carryability than the professional imaging device, the video reporter can arrive at the scene of the incident and cover the incident earlier than the broadcast reporter using the professional imaging device. Furthermore, the broadcast station 2000 can request the video reporter who is near the scene of the incident and who has the terminal device 200 to cover the incident continuously. On the other hand, since the professional imaging device requires more time for preparation than the terminal device 200, it is considered that the professional imaging device may arrive at the scene of the incident and cover the incident later than the broadcast reporter.

When imaging and editing at the scene of the incident are completed, the video reporter using the terminal device 200 transmits video data as coverage contents to the broadcast station 2000 via the server 3000. The broadcast station 2000 that has received the video data makes the first report using the video captured by using the terminal device 200. As a result, it is possible to report the incident more immediately than in a conventional case where only the professional imaging device is used. Such a coverage method is suitable, for example, when contents of an incident are reported in real time in a case where the incident occurs during live broadcasting of a news program or the like broadcast in the daytime. Note that the video reporter using the terminal device 200 can continue the imaging continuously at the scene of the incident. Furthermore, the case where the terminal device 200 transmits the edited video data as coverage contents to the broadcast station 2000 has been described, but for example, the editing performed by the terminal device 200 may be processing for broadcasting, or the video reporter may transmit, to the broadcast station 2000, only text data such as a coverage memo as coverage contents together with the video, and editing such as processing for broadcasting may be performed on the side of the broadcast station 2000.

When imaging and editing at the scene of the incident are completed, the broadcast reporter using the professional imaging device transmits video data to the broadcast station 2000 via the server 3000. The broadcast station 2000 that has received the video data makes a further report after the first report using the video data. Since the professional imaging device has higher performance than the terminal device 200, it is possible to perform detailed reporting with higher image quality than that of the video captured by the terminal device 200. Such a coverage method is suitable, for example, when an incident covered by a video reporter in the daytime is additionally covered and further detailed contents are broadcast in a news program in the evening or night. However, the broadcast reporter may provide unique coverage contents different from those of the video reporter. Note that the broadcast reporter can also continue the imaging continuously at the scene of the incident.

### 3. Second Aspect of Coverage in MOJO]

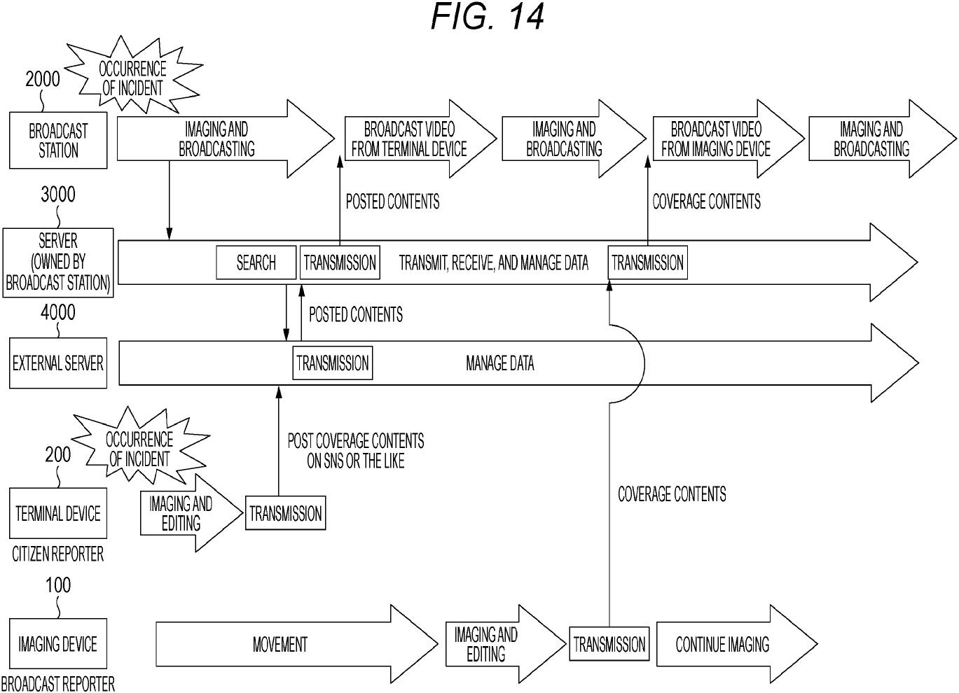

FIG. 14 illustrates a second coverage aspect of MOJO in which broadcasting is performed on the basis of coverage by a citizen reporter using the terminal device 200 and a broadcast reporter using the imaging device 100 as a professional imaging device.

In the second coverage aspect, there is an external server 4000 for providing services on the Internet, which is different from the server 3000 or the like used by the broadcast station 2000. Services on the Internet include various social network services (SNSs), video distribution sites, blog sites, Internet televisions, and the like.

Since the citizen reporter is a common citizen having no employment relationship with the broadcast station 2000, the broadcast station 2000 and the citizen reporter separately know the occurrence of an incident in this second coverage aspect. Therefore, even if there is no request for coverage from the broadcast station 2000, the citizen reporter covers the incident freely. The citizen reporter can perform imaging and editing as coverage as soon as the citizen reporter finds the incident by chance or encounters the incident.

The citizen reporter who has encountered the incident performs imaging and the like as coverage using the terminal device 200. Note that, since the terminal device 200 is generally excellent in portability, carryability, and a communication function as compared with the professional imaging device, it is considered that the citizen reporter can post and provide coverage contents earlier than the broadcast reporter. Note that, in some cases, the citizen reporter attaches a text to the captured video. Furthermore, there is a case where editing work is performed on the video captured by the citizen reporter in the broadcast station 2000 or the server of the broadcast station 2000.

When imaging and editing are completed, the citizen reporter using the terminal device 200 posts the coverage contents on an SNS, a video distribution site, or the like on the Internet. This is the first report that does not go through the broadcast station 2000. This enables more immediate reporting than conventional reporting performed by the broadcast station 2000.

The broadcast station 2000 periodically searches SNSs, video distribution sites, blog sites, and the like, and when finding that the citizen reporter has posted the incident on the Internet, the broadcast station 2000 requests the citizen reporter to provide information, and acquires the posted contents.

The broadcast station 2000 that has obtained the posted contents reports the incident using the posted contents. This enables more immediate reporting than coverage and reporting by video reporters and broadcast reporters.

Furthermore, the broadcast station 2000 may request the citizen reporter to supply the coverage contents such as video data in real time. This makes it possible to perform real-time reporting (live broadcasting) using the video captured by the citizen reporter.

Furthermore, when imaging and editing are completed, the broadcast reporter using the professional imaging device transmits video data to the broadcast station 2000 via the server 3000. The broadcast station 2000 that has received the video data makes a further report after the first report using the video captured by the camera. Since the professional imaging device has higher performance than the terminal device 200, it is possible to perform detailed reporting with higher image quality than that of the video captured by the terminal device 200. Furthermore, the broadcast station 2000 can also perform real-time reporting (live broadcasting) by using the video transmitted from the broadcast reporter.

The examples of the coverage aspects of MOJO are as described above. Note that the coverage aspects in FIGS. 13 and 14 are merely examples.

In such a reporting method, a report may be made by live broadcast reporting or real-time video streaming. In such live broadcasting or real-time video streaming, there is a case where a reporter wants to confirm what kind of video the broadcast station 2000 is currently broadcasting and how a video captured by the reporter is being broadcast. In such a case, the present technology is useful.

Specifically, the reporter 1000 (citizen reporter, video reporter, and broadcast reporter) possesses the imaging device 100 and the terminal device 200, and performs imaging and editing with the imaging device 100 at the scene of an incident. The imaging data is then transmitted to the broadcast station 2000 via the server 3000. While broadcasting by use of the imaging data, the broadcast station 2000 transmits the broadcast contents as return video data to the terminal device 200 of the reporter 1000. By displaying the return video data on the terminal device 200, the reporter 1000 can confirm the broadcast contents on the terminal device 200 while performing imaging with the imaging device 100. In addition, it is also possible to give an instruction or have a consultation, a meeting, or the like by a voice call between the broadcast station 2000 and the reporter 1000.

### 3. Modification

Although the embodiment of the present technology has been specifically described above, the present technology is not limited to the above-described embodiment, and various modifications based on the technical idea of the present technology are possible.

In the embodiment, video data has been described as a specific example, but the present technology can be applied to any data such as image data, audio data, text data, statistical data, measurement data, and data for a program or application.

The present technology can be applied not only to reporting such as MOJO but also to any broadcasting such as a live broadcast drama and a live broadcast variety program.

In the embodiment, the description has been made assuming that the first communication scheme is 4G and the second communication scheme is 5G, but the communication schemes are not limited thereto. The second communication scheme may be any communication scheme as long as the second communication scheme has higher speed and larger capacity than the first communication scheme. Therefore, in a case where a communication scheme having a higher speed and a larger capacity than 5G, for example, the sixth generation mobile communication system (6G) is put into practical use in the future, setting the first communication scheme to 5G and the second communication scheme to 6G makes it possible to apply the present technology. It is similar for communication schemes of 6G and after.

The present technology may have the following configurations.

An imaging device including:
a communication unit that communicates by use of both or one of a first communication scheme and a second communication scheme capable of communicating at a higher speed than the first communication scheme;
a determination unit that determines whether the second communication scheme is available; and
a function control unit that performs control related to a function according to a determination result of the determination unit.

The imaging device according to (1), in which the function control unit changes the function depending on whether the second communication scheme is available or unavailable.

The imaging device according to (1) or (2), in which the function control unit sets a communication scheme to the second communication scheme or sets the communication scheme to both the first communication scheme and the second communication scheme in a case where the second communication scheme is available.

The imaging device according to any one of (1) to (3), in which the function control unit sets a data transmission method to a streaming format in a case where the second communication scheme is available.

The imaging device according to any one of (1) to (4), in which the function control unit sets a data transmission method to a downloading format in a case where the second communication scheme is unavailable.

The imaging device according to any one of (1) to (5), in which the function control unit directly transmits data to an external storage medium or storage device to store the data in a case where the second communication scheme is available.

The imaging device according to any one of (1) to (6), in which, in a case where the second communication scheme is available, the function control unit lowers a compression rate of video data generated by imaging in a codec as compared with a case where the first communication scheme is used, and in a case where the second communication scheme is unavailable, the function control unit increases the compression rate of the video data in the codec as compared with a case where the second communication scheme is used.

The imaging device according to any one of (1) to (7), in which, in a case where the second communication scheme is available, the function control unit increases a frame rate of video data generated by imaging as compared with a case where the first communication scheme is used, and in a case where the second communication scheme is unavailable, the function control unit lowers the frame rate of the video data as compared with a case where the second communication scheme is used.

The imaging device according to any one of (1) to (8), in which, in a case where the second communication scheme is available, the function control unit increases a resolution of video data generated by imaging as compared with a case where the first communication scheme is used, and in a case where the second communication scheme is unavailable, the function control unit lowers the resolution of the video data as compared with a case where the second communication scheme is used.

The imaging device according to any one of (1) to (9), further including a display unit,

in which the function control unit displays, on the display unit, information indicating that the second communication scheme is available.

The imaging device according to any one of (1) to (10), further including a display unit,

in which the function control unit displays area information indicating an available range of the second communication scheme on the display unit.

The imaging device according to any one of (1) to (11), further including a display unit,

in which the function control unit displays information indicating a radio field intensity of the second communication scheme on the display unit.

The imaging device according to any one of (1) to (12), further including a display unit,

in which the function control unit displays, on the display unit, information indicating that data is capable of being directly transmitted to an external storage medium or storage device and being stored in the external storage medium or storage device by use of the second communication scheme.

The imaging device according to any one of (1) to (13), in which the determination unit makes a determination on the basis of whether or not a radio field intensity in a frequency band of the second communication scheme is equal to or greater than a predetermined value.

The imaging device according to any one of (1) to (14), further including a position information acquisition unit that acquires current position information,

in which the determination unit makes a determination on the basis of the current position information acquired by the position information acquisition unit and area information indicating an available range of the second communication scheme.

A method for controlling an imaging device capable of communicating by use of both or one of a first communication scheme and a second communication scheme capable of communicating at a higher speed than the first communication scheme, the method including:
determining whether the second communication scheme is available; and
performing control related to a function according to a determination result.

A control program for causing a computer to execute a method for controlling an imaging device capable of communicating by use of both or one of a first communication scheme and a second communication scheme capable of communicating at a higher speed than the first communication scheme, the method including:
determining whether the second communication scheme is available; and
performing control related to a function according to a determination result.

An information processing device including:
a communication unit that communicates with an imaging device; and
a reception control unit that performs control to receive data transmitted from the imaging device by first reception processing and second reception processing in a case where information indicating that the imaging device communicates by a predetermined communication scheme is received.

The information processing device according to (18), in which, in a case where the imaging device communicates through a line other than the predetermined communication scheme, the reception control unit receives the data transmitted from the imaging device by either the first reception processing or the second reception processing.

The information processing device according to (18) or (19), in which the first reception processing is reception in a streaming format, and the second reception processing is reception in a downloading format.

A method for controlling an information processing device, the method including:
communicating with an imaging device; and
performing control to receive data transmitted from the imaging device by first reception processing and second reception processing in a case where information indicating that the imaging device communicates by a predetermined communication scheme is received.

A control program for causing a computer to execute a method for controlling an information processing device, the method including:
communicating with an imaging device; and
performing control to receive data transmitted from the imaging device by first reception processing and second reception processing in a case where information indicating that the imaging device communicates by a predetermined communication scheme is received.

REFERENCE SIGNS LIST

| | |
|---|---|
| 100 | Imaging device |
| 108 | First communication unit |
| 109 | Second communication unit |
| 117 | Determination unit |
| 118 | Function control unit |
| 300 | Information processing device |

1. An imaging device comprising:
a communication unit that communicates by use of both or one of a first communication scheme and a second communication scheme capable of communicating at a higher speed than the first communication scheme;
a determination unit that determines whether the second communication scheme is available; and
a function control unit that performs control related to a function according to a determination result of the determination unit.

2. The imaging device according to claim 1,
wherein the function control unit changes the function depending on whether the second communication scheme is available or unavailable.

3. The imaging device according to claim 1,
wherein the function control unit sets a communication scheme to the second communication scheme or sets the communication scheme to both the first communication scheme and the second communication scheme in a case where the second communication scheme is available.

4. The imaging device according to claim 1,
wherein the function control unit sets a data transmission method to a streaming format in a case where the second communication scheme is available.

5. The imaging device according to claim 1,
wherein the function control unit sets a data transmission method to a downloading format in a case where the second communication scheme is unavailable.

6. The imaging device according to claim 1,
wherein the function control unit directly transmits data to an external storage medium or storage device to store the data in a case where the second communication scheme is available.

7. The imaging device according to claim 1,
wherein in a case where the second communication scheme is available, the function control unit lowers a compression rate of video data generated by imaging in a codec as compared with a case where the first communication scheme is used, and in a case where the second communication scheme is unavailable, the function control unit increases the compression rate of the video data in the codec as compared with a case where the second communication scheme is used.

8. The imaging device according to claim 1,
wherein in a case where the second communication scheme is available, the function control unit increases a frame rate of video data generated by imaging as compared with a case where the first communication scheme is used, and in a case where the second communication scheme is unavailable, the function control unit lowers the frame rate of the video data as compared with a case where the second communication scheme is used.

9. The imaging device according to claim 1,
wherein in a case where the second communication scheme is available, the function control unit increases a resolution of video data generated by imaging as compared with a case where the first communication scheme is used, and in a case where the second communication scheme is unavailable, the function control unit lowers the resolution of the video data as compared with a case where the second communication scheme is used.

10. The imaging device according to claim 1, further comprising
a display unit,
wherein the function control unit displays, on the display unit, information indicating that the second communication scheme is available.

11. The imaging device according to claim 1, further comprising
a display unit,
wherein the function control unit displays area information indicating an available range of the second communication scheme on the display unit.

12. The imaging device according to claim 1, further comprising
a display unit,
wherein the function control unit displays information indicating a radio field intensity of the second communication scheme on the display unit.

13. The imaging device according to claim 1, further comprising
a display unit,
wherein the function control unit displays, on the display unit, information indicating that data is capable of being directly transmitted to an external storage medium or storage device and being stored in the external storage medium or storage device by use of the second communication scheme.

14. The imaging device according to claim 1,
wherein the determination unit makes a determination on a basis of whether or not a radio field intensity in a frequency band of the second communication scheme is equal to or greater than a predetermined value.

15. The imaging device according to claim 1, further comprising
a position information acquisition unit that acquires current position information,
wherein the determination unit makes a determination on a basis of the current position information acquired by the position information acquisition unit and area information indicating an available range of the second communication scheme.

16. A method for controlling an imaging device capable of communicating by use of both or one of a first communication scheme and a second communication scheme capable of communicating at a higher speed than the first communication scheme, the method comprising:
determining whether the second communication scheme is available; and
performing control related to a function according to a determination result.

17. (canceled)

18. An information processing device comprising:
a communication unit that communicates with an imaging device; and
a reception control unit that performs control to receive data transmitted from the imaging device by first reception processing and second reception processing in a case where information indicating that the imaging device communicates by a predetermined communication scheme is received.

19. The information processing device according to claim 16,
wherein in a case where the imaging device communicates through a line other than the predetermined communication scheme, the reception control unit receives the data transmitted from the imaging device by either the first reception processing or the second reception processing.

20. The information processing device according to claim 16,
wherein the first reception processing is reception in a streaming format, and the second reception processing is reception in a downloading format.

21-22. (canceled)
